(19) United States
(12) Patent Application Publication
(10) Pub. No.: US 2017/0122775 A1
(43) Pub. Date: May 4, 2017

(54) MOTION DETECTING DEVICE AND MOTION ANALYZING SYSTEM

(71) Applicant: SEIKO EPSON CORPORATION, Tokyo (JP)

(72) Inventors: Yuya ISHIKAWA, Chino-shi (JP); Makoto SAKURAI, Okaya-shi (JP)

(73) Assignee: SEIKO EPSON CORPORATION, Tokyo (JP)

(21) Appl. No.: 15/292,744

(22) Filed: Oct. 13, 2016

(30) Foreign Application Priority Data
Nov. 2, 2015 (JP) 2015-215501

(51) Int. Cl. G01D 5/12

(52) U.S. Cl. CPC G01D 5/12; G06K 9/00342

(57) ABSTRACT

A motion detecting device includes an electronic component (a sensor) including a sensor section that detects motion on the basis of a detection result of an electronic device functioning as a detection element that detects magnetism and a holding tool attached to a golf club functioning as a moving body, the holding tool including fitting sections functioning as a fixing section that fixes the electronic component (the sensor). A magnetic body is provided in the holding tool.

### BACKGROUND

1. Technical Field

The present invention relates to a motion detecting device and a motion analyzing system including the motion detecting device.

2. Related Art

As a method of detecting, analyzing, and evaluating motions involved in swings of a golf club, a baseball bat, and human bodies that handle the exercise instruments, there has been known a method of detecting and analyzing motions on the basis of images picked up by a camera. In the detection and the analysis by the images, there is a limit in accuracy and equipment is increased in size. Therefore, it has been attempted to perform more highly accurate motion detection and motion analysis with compact equipment using a sensor such as an acceleration sensor, a gyro sensor, or a terrestrial magnetism sensor. For example, JP-A-2010-068947 (Patent Literature 1) introduces a motion detecting device (a portable terminal device) that detects motions of a user such as a golf swing using a sensor (a terrestrial magnetism sensor) that detects motion on the basis of a detection result of a detection element that detects magnetism. The terrestrial magnetism sensor outputs a motion of the user as a temporal terrestrial magnetism change.

However, when a motion of the golf swing of the user is detected using the motion detecting device described in Patent Literature 1, disturbance of terrestrial magnetism caused around a metal shaft of a golf club is included in an output value of a detection result. It is likely that an error occurs in a measurement value of the motion.

### SUMMARY

An advantage of some aspects of the invention is to solve at least a part of the problems described above, and the invention can be implemented as the following forms or application examples.

### Application Example 1

A motion detecting device according to this application example includes: a sensor including a detection element configured to detect magnetism; and a holding tool attached to a moving body and including a fixing section configured to fix the sensor. A magnetic body is provided in the holding tool.

According to this application example, when motion of a moving body including a metal component such as a golf club is detected, it is possible to reduce, with the magnetic body provided in the holding tool, disturbance of terrestrial magnetism caused around the moving body and suppress a detection error of motion due to the disturbance of the terrestrial magnetism.

### Application Example 2

In the motion detecting device according to the application example, it is preferable that the magnetic body is disposed to be symmetrical with respect to an imaginary center line extending along a direction in which the sensor and the holding tool are arranged side by side and passing the moving body.

With this application example, in a state in which the sensor is fixed to the holding tool attached to the moving body, the magnetic body is disposed in the moving body in a well-balanced state. Therefore, when the motion of the moving body is detected, it is possible to more effectively suppress the influence of the disturbance of the terrestrial magnetism.

### Application Example 3

In the motion detecting device according to the application example, it is preferable that the magnetic body is disposed on the inside of the holding tool.

With the application example, since the magnetic body is not in contact with and is not exposed to the moving body and an external environment, damage, soil, and the like due to friction and the like less easily occur. Therefore, it is possible to retain the suppression effect of the detection error of the motion detection by the magnetic body.

### Application Example 4

In the motion detecting device according to the application example, it is preferable that the magnetic body is disposed on a surface of the holding tool on the moving body side.

With this application example, it is possible to form the holding tool provided with the magnetic body by a simple method of, for example, sticking the magnetic body to the holding tool. Further, since the magnetic body is disposed on the surface on the moving body side, there is an effect that it is possible to reduce friction and damage received by the magnetic body from the outside during use.

### Application Example 5

In the motion detecting device according to the application example, it is preferable that the magnetic body is disposed on a surface on the opposite side of a surface of the holding tool on the moving body side.

With this application example, it is possible to form the holding tool provided with the magnetic body according to the simple method of, for example, sticking the magnetic body to the holding tool. Further, since the magnetic body is retained by the moving body in a state in which the magnetic body is not in contact with the moving body, it is possible to prevent occurrence of scratches and soil due to the contact of the magnetic body with the moving body.

### Application Example 6

In the motion detecting device according to the application example, it is preferable that fitting sections are respectively provided in the holding tool and the sensor, and the sensor and the holding tool are fixed by fitting the fitting sections with each other.

With this application example, it is possible to obtain the motion detecting device easily attached to the moving body.

### Application Example 7

A motion analyzing system according to this application example 7 includes: the motion detecting device according to any one of the application examples explained above; a data acquiring section configured to acquire motion data of the moving body obtained by the motion detecting device; and a computer configured to analyze the motion data acquired by the data acquiring section.

According to this application example, since the motion analyzing system includes the motion detecting device according to any one of the application examples, it is possible to reduce disturbance of terrestrial magnetism caused around the moving body, acquire motion data in which a detection error of motion due to the disturbance of the terrestrial magnetism is suppressed, and perform motion analysis on the basis of the motion data. Therefore, it is possible to provide a motion analyzing system capable of performing highly accurate motion analysis.

### BRIEF DESCRIPTION OF THE DRAWINGS

The invention will be described with reference to the accompanying drawings, wherein like numbers reference like elements.

FIG. 1 is an exterior perspective view of a state in which a holding tool according to an embodiment is attached to a moving body (a golf club).

FIG. 2 is an enlarged view of a range indicated by A in FIG. 1 and is a schematic view showing a state in which an electronic component (a sensor) is fit in the holding tool according to the embodiment.

FIG. 3 is an enlarged view of the range indicated by A in FIG. 1 and is a schematic view showing a state in which the holding tool according to the embodiment is attached to a moving body and the electronic component is fit in the holding tool according to the embodiment.

FIG. 4 is a perspective view of the holding tool according to the embodiment and is a perspective view viewed from a direction of an arrow indicated by J in FIG. 12.

FIG. 5A is a sectional view schematically showing an example of a magnetic body included in the holding tool according to the embodiment.

FIG. 5B is a side view schematically showing the example of the magnetic body included in the holding tool according to the embodiment.

FIG. 5C is an explanatory diagram equivalent to a state in which the holding tool according to the embodiment is imaginarily developed on a plane.

FIG. 6 is a schematic top plan view of an electronic component according to the embodiment.

FIG. 7 is a schematic bottom plan view of the electronic component according to the embodiment.

FIG. 8 is a schematic view of the electronic component according to the embodiment viewed from a direction of an arrow indicated by F in FIG. 6.

FIG. 9 is a schematic sectional view of the electronic component according to the embodiment taken along line B-B′ in FIGS. 6 and 7.

FIG. 10 is a schematic sectional view of the electronic component according to the embodiment taken along line C-C′ in FIG. 7 and line E-E′ in FIG. 8.

FIG. 11 is a schematic plan view of the holding tool according to the embodiment viewed from a side of an attachment surface.

FIG. 12 is a schematic view of the holding tool according to the embodiment viewed from a direction of an arrow indicated by G in FIG. 11.

FIG. 13 is a schematic view of the holding tool according to the embodiment viewed from a direction of an arrow indicated by H in FIG. 11.

FIG. 14 is a schematic sectional view of a state in which the holding tool according to the embodiment is attached to a moving body (a golf club).

FIG. 15 is a schematic sectional view of a state in which the electronic component is fit in the holding tool according to the embodiment.

FIG. 16 is an enlarged view of a range indicated by J in FIG. 15.

FIG. 17A is a sectional view schematically showing an example of a magnetic body included in a holding tool according to a modification 1.

FIG. 17B is an explanatory diagram equivalent to a state in which the holding tool according to the modification 1 is imaginarily developed on a plane.

FIG. 18 is an explanatory diagram equivalent to a state in which a holding tool according to a modification 2 is imaginarily developed on a plane.

FIG. 19 is a sectional view schematically showing an example of a magnetic body included in a holding tool according to a modification 3.

FIG. 20 is a sectional view schematically showing an example of a magnetic body included in a holding tool according to a modification 4.

FIG. 21 is an exterior view showing a motion analyzing system including a motion detecting device.

FIG. 22 is a block diagram showing the motion analyzing system.

### DESCRIPTION OF EXEMPLARY EMBODIMENTS

An embodiment of the invention is explained below with reference to the drawings. Note that, in the figures referred to below, layers and members are shown in scales different from actual scales in order to show the layers and the members in recognizable sizes.

### 1. Motion Detecting Device

### 1.1. Holding Tool

In a motion detecting device in this embodiment, a holding tool is formed in a holding tool shape and attached to a moving body to grasp the moving body. The holding tool is a jig or an attachment for attaching an electronic component such as a sensor explained below to the moving body.

### 1.2. Moving Body

The moving body to which the holding tool and the electronic component are attached is explained. The moving body to which the holding tool in this embodiment is attached is not limited as long as the moving body has a shape that can be grasped such as a bar shape, a column shape, or a cylinder shape and performs motion (spatial movement of a position, changes in a shape and a posture, rotation, vibration, and the like). Examples of the moving body include instruments used in various athletic games such as a golf club, a baseball bat, a tennis racket, and a bamboo sword and, besides the instruments, parts of a human body such as arms and feet, and movable sections such as arms of a robot apparatus.

In the following explanation, it is assumed that the moving body is a golf club. The golf club is not particularly limited. In this embodiment, a rubber grip is attached to a shaft. Note that, in the following explanation, the holding tool in this embodiment grasps the portion of the rubber grip. However, the holding tool may grasp the shaft or may grasp a boundary section between the rubber grip and the shaft.

### 1.3. Shape of the Holding Tool

The holding tool in this embodiment has a bent plate shape. The holding tool has a shape for grasping a bar-shaped moving body. The holding tool grasps the moving body to thereby be attached to the moving body. A holding tool 20 in this embodiment grasps a golf club 200 (the moving body). The holding tool 20 may include other members (e.g., a mechanism for fixing an electronic component 10).

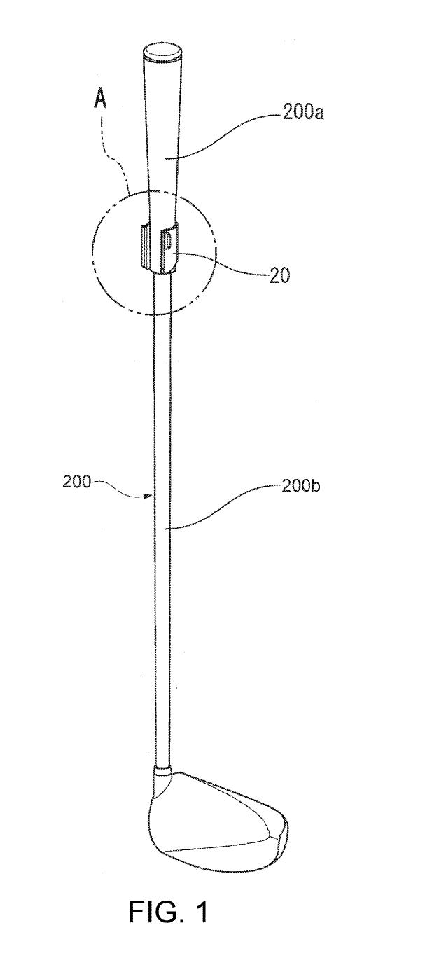

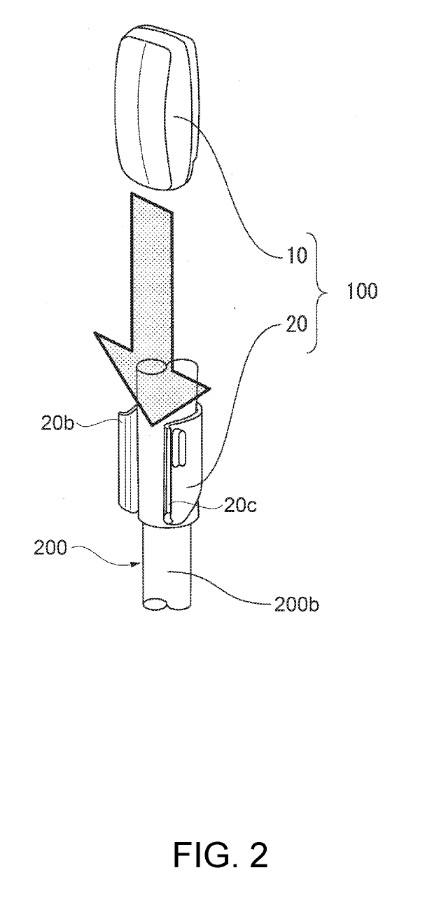

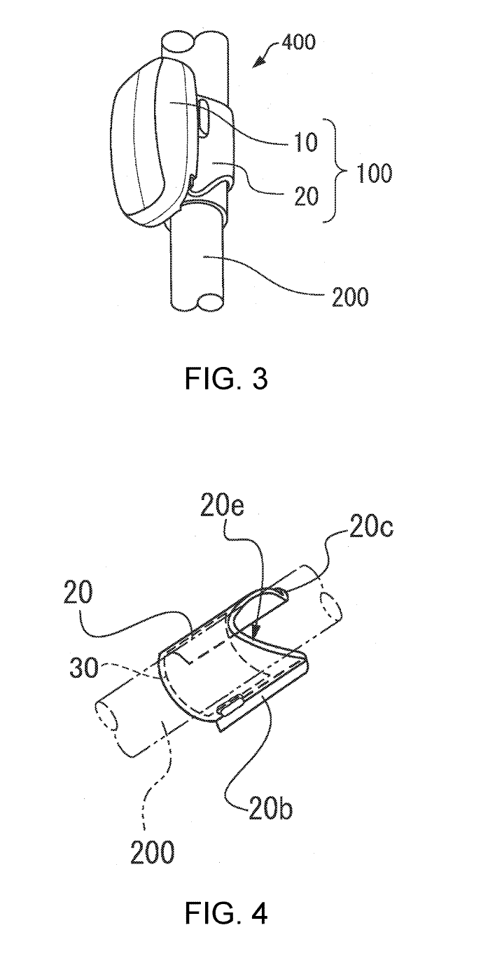

FIG. 1 is an exterior perspective view of a state in which the holding tool 20 according to the embodiment is attached to the golf club 200 (an exercise instrument) functioning as a moving body. FIG. 2 is an enlarged view of a range indicated by A in FIG. 1 and is a schematic view showing a state in which the electronic component (a sensor) 10 is fit in the holding tool 20 according to the embodiment. FIG. 3 is an enlarged view of the range indicated by A in FIG. 1 and is a schematic view showing a state in which the holding tool 20 according to the embodiment is attached to a moving body and the electronic component 10 is fit in the holding tool 20.

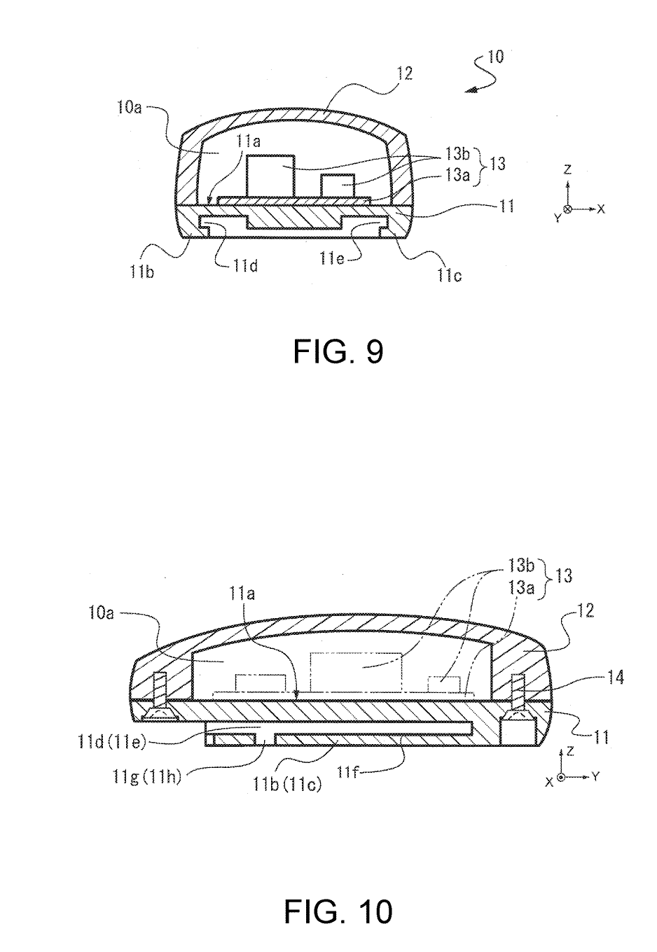

According to FIGS. 1 and 2, the electronic component 10 including a sensor section 13 (see FIGS. 9 and 10) such as a terrestrial magnetism sensor or an inertial sensor not shown in the figures is attached to, in an arrow direction shown in FIG. 2, via fitting sections 20b and 20c, the holding tool 20 attachable to a grip section 200a of the golf club 200. The electronic component 10 is attached to the golf club 200 as shown in FIG. 3.

As shown in FIG. 3, a motion detecting device 100 (including the holding tool 20 and the sensor section 13 included in the electronic component 10 fit in the holding tool 20) according to the embodiment is attached to the golf club 200 functioning as the moving body. That is, when the holding tool 20 is attached to the golf club 200 and the fitting sections 20b and 20c fit with the electronic component 10, the electronic component 10 is attached to the golf club 200 to surround the golf club 200.

In this specification, “the holding tool grasps the moving body” indicates that the holding tool is attached and fixed (held, etc.) to grasp (clutch, grip, etc.) the moving body having a bar shape, a column shape, a cylinder shape, or the like and indicates a state in which the holding tool is fixed (supported) not to cover the entire circumference of the moving body and to cover at least a half circumference of the moving body. Such a form can be rephrased as “the holding tool grips the moving body”, “the holding tool is attached to the moving body by gripping the moving body”, and the like.

The material of the holding tool 20 is not limited as long as an urging force for grasping the golf club 200 is obtained. However, the material of the holding tool 20 can contribute to a reduction in weight if synthetic resin such as polyethylene, polypropylene, polystyrene, polyvinyl chloride, polycarbonate, ABS resin, fluorine-based resin, acrylate-based resin, or a copolymer of these materials is used.

### 1.4. Fitting Sections

The holding tool 20 may include, on the distal end side for grasping the moving body, the fitting sections 20b and 20c functioning as a fixing section. The distal end side for grasping the moving body is a part that grabs the moving body first when the holding tool 20 grasps the moving body. The fitting sections 20c and 20c function as, for example, components for fitting with the electronic component 10 explained below. The fitting sections 20b and 20c can stably attach the electronic component 10 to the golf club 200 without easily causing coming-off, positional deviation, rotation, and the like.

Details of the fitting sections 20b and 20c are also explained below. When the holding tool 20 is attached to the golf club 200 and the fitting sections 20b and 20c fit with the electronic component 10, the electronic component 10 and the holding tool 20 (the motion detecting device 100) are attached to surround the golf club 200. Further, when the fitting sections 20b and 20c fit with the electronic component 10, a degree of urging to the golf club 200 may increase. Consequently, it is possible to more stably attach the electronic component 10 to the golf club 200 without easily causing coming-off, positional deviation, rotation, and the like.

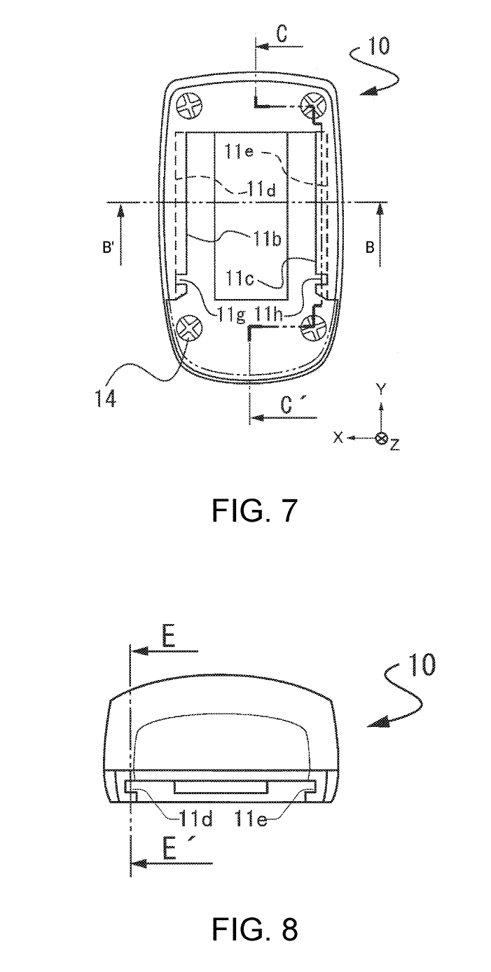

Note that, in this embodiment, the fitting sections 20b and 20c have a rail shape. The fitting sections 20b and 20c are inserted through grooves 11d and 11e (see FIG. 7) of the electronic component 10 explained in detail below to thereby slide with respect to the electronic component 10 and fit with the electronic component 10. However, not only this, but the fitting sections 20b and 20c only have to be capable of fixing the electronic component 10 to the golf club 200.

### 1.5. Magnetic Body

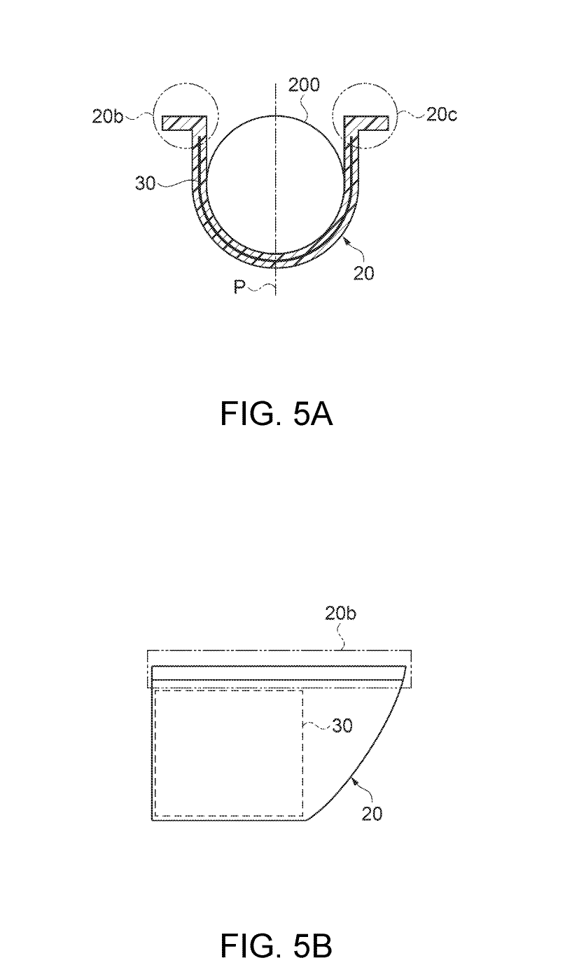

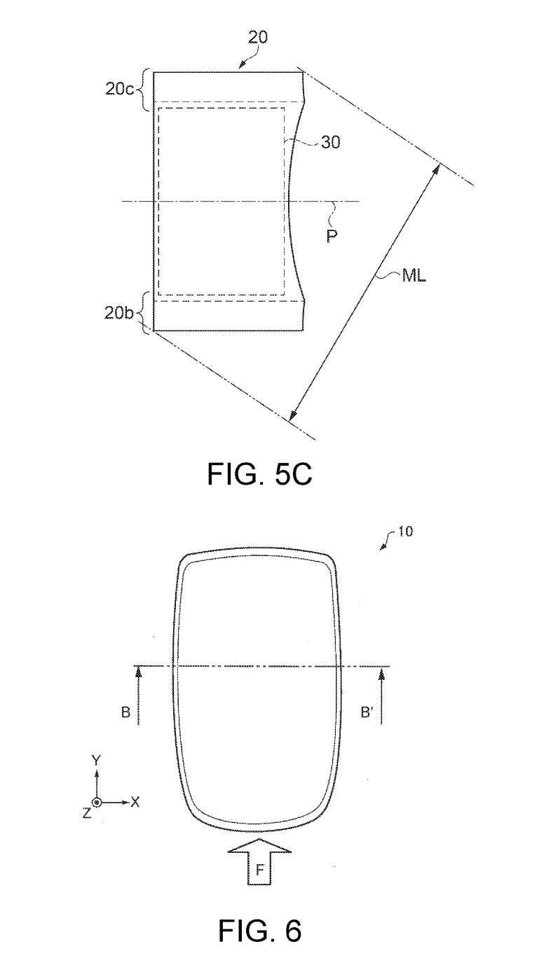

A magnetic body 30, which is a most characteristic component provided in the holding section 20 in the motion detecting device 100 in this embodiment, is explained. FIG. 4 is a perspective view of the holding tool 20 according to the embodiment and is a perspective view viewed from a direction of an arrow indicated by J in FIG. 12. FIGS. 5A and 5B schematically show an example of the magnetic body 30 included in the holding tool 20. FIG. 5A is a sectional view and FIG. 5B is a side view. FIG. 5C is an explanatory diagram equivalent to a state in which the holding tool 20 is imaginarily developed on a plane.

As shown in FIG. 4, in the holding tool 20, the magnetic body 30 is provided to be embedded in the inside of the holding tool 20 (to be covered by the material forming the holding tool 20). In an exercise instrument 400 (see FIG. 3) attached with a sensor, in which the motion detecting device 100 is fixed to the golf club 200 via the holding tool 20, when detection of motion such as swing motion of the golf club 200 functioning as the moving body is performed by a terrestrial magnetism sensor included in the electronic component (the sensor) 10, the magnetic body 30 reduces the influence of disturbance of terrestrial magnetism caused around a metal shaft section 200b (see FIGS. 1 and 2) of the golf club 200 and suppresses a detection error of motion.

As shown in FIGS. 5A to 5C, the magnetic body 30 is desirably disposed in the holding tool 20 to cover the circumference of the golf club 200 when the holding tool 20 is attached to the golf club 200. The magnetic body 30 is desirably disposed in size for covering the circumference of the golf club 200 as wide as possible within a range of the size of the holding tool 20. As shown in FIG. 5C, the magnetic body 30 is desirably disposed to be symmetrical with respect to an imaginary center line P passing the golf club 200 along a direction in which the electronic component (the sensor) 10 and the holding tool 20 are arranged side by side. Consequently, the magnetic body 30 is disposed in a well-balanced state with respect to the golf club 200 (the shaft section 200b) functioning as the moving body. When motion such as swing motion of the golf club 200 is detected, it is possible to more effectively suppress the influence of the disturbance of the terrestrial magnetism.

As the material of the magnetic body 30, it is desirable to use a ferromagnetic body or a ferrimagnetic body having strong magnetization such as ferrite containing, as a main component, iron, cobalt, nickel, an alloy of iron, cobalt, and nickel, or iron oxide. In the magnetic body 30, a paramagnetic body having magnetism only when an external magnetic field is present such as manganese or platinum or a diamagnetic body such as copper or aluminum can also be used as the material.

### 1.6. Electronic Component (Sensor)

FIG. 6 is a schematic top plan view of the electronic component 10 functioning as the sensor according to the embodiment. FIG. 7 is a schematic bottom plan view of the electronic component 10 according to the embodiment. FIG. 8 is a schematic view of the electronic component 10 according to the embodiment viewed from a direction of an arrow indicated by F in FIG. 6. FIG. 9 is a schematic sectional view of the electronic component 10 according to the embodiment taken along line B-B′ in FIGS. 6 and 7. FIG. 10 is a schematic sectional view of the electronic component 10 according to the embodiment taken along line C-C′ in FIG. 7 and line E-E′ in FIG. 8. The electronic component 10 is explained in detail below with reference to FIGS. 6 to 10.

As shown in FIGS. 9 and 10, the electronic component 10 configures a housing in which an internal space 10a is formed by a cover 12 fixed to a base 11 by screws 14. A circuit board 13a, which is the sensor section 13 functioning as detecting means of the electronic component 10 configured by electronic devices 13b and the circuit board 13a on which the electronic devices 13b are mounted, is firmly attached to a surface 11a of the base 11 on the internal space 10a side by means such as bonding. Note that at least one of the electronic devices 13b is a terrestrial magnetism sensor that detects motion on the basis of a detection result of a detection element that detects magnetism. The sensor section 13 may include inertial sensors such as an acceleration sensor and an angular velocity sensor. Further, the sensor section 13 can be configured as appropriate to be capable of, for example, analyzing motions of three axes.

Means for fixing the cover 12 to the base 11 is not limited to the screws 14 and may be, for example, bonding. The cover 12 can also be fixed to the base 11 by welding if the base 11 and the cover 12 are formed of plastics.

In the base 11, as shown in FIGS. 7 and 8, a protrusion 11b and a protrusion 11c are extended in parallel along a Y direction shown in the figures. The groove 11d functioning as a recessed portion is formed along the Y direction in the protrusion 11b. The groove 11e functioning as a recessed portion is formed along the Y direction in the protrusion 11c. Openings in an X direction of the grooves 11d and 11e are formed to be opposed to each other. Sides in the Y(−) direction of the grooves 11d and 11e, that is, sides of the grooves 11d and 11e in an inserting direction of the electronic component 10 shown in FIG. 2 are opened. A groove wall 11f is formed in the opposite direction. As engaging sections engaging with slip prevention protrusions of the holding tool 20, a cutout section 11g is formed in the protrusion 11b and a cutout section 11h is formed in the protrusion 11c.

### 1.7. Fitting and Assembling

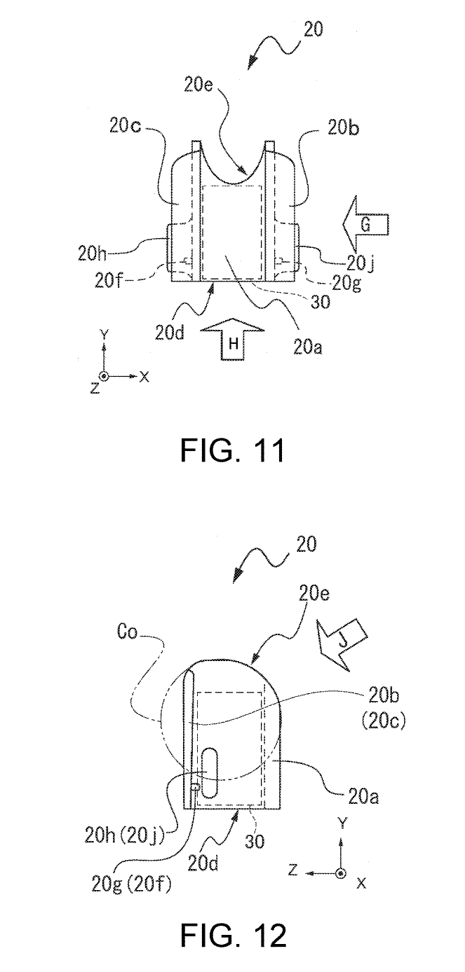

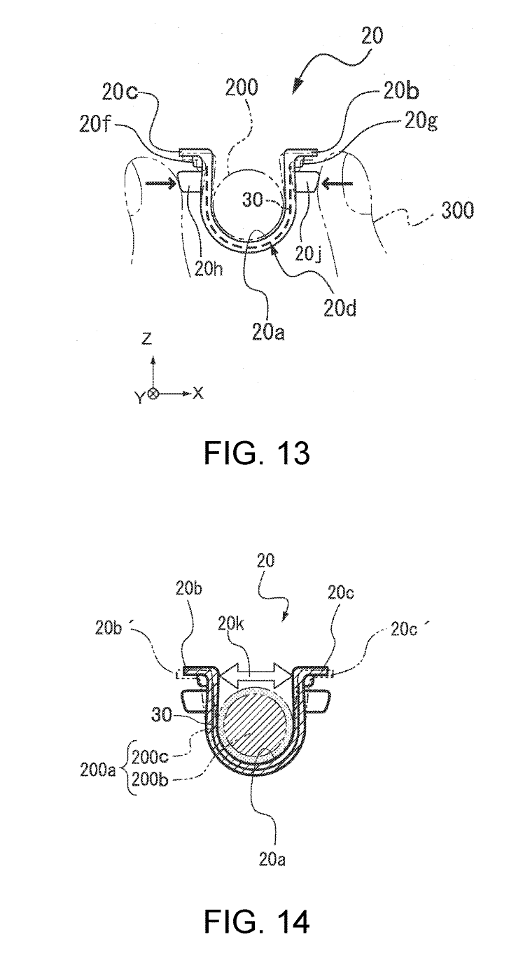

FIGS. 11 to 13 show the holding tool 20 according to the embodiment. FIG. 11 is a schematic plan view of the holding tool 20 according to the embodiment viewed from a side of an attachment surface. FIG. 12 is a schematic view of the holding tool 20 viewed from a direction of an arrow indicated by G in FIG. 11. FIG. 13 is a schematic view of the holding tool 20 viewed from a direction of an arrow indicated by H in FIG. 11.

As shown in FIG. 13, the holding tool 20 includes an attachment surface 20a attached to twine around the golf club 200 functioning as the moving body, the fitting section 20b functioning as a projecting portion projecting in the X(+) direction and extending in the Y direction and inserted through the groove 11d (see FIGS. 7 to 9) of the electronic component 10, and the fitting section 20c functioning as a projecting portion projecting in the X(−) direction and extending in the Y direction and inserted through the groove 11e (see FIGS. 7 to 9).

As shown in FIG. 12, one end portion 20d in the ±Y direction of the holding tool 20 is formed along an X-Z plane. The other end portion 20e crosses the X-Z plane. In this example, the other end portion 20e is formed in a shape conforming to a columnar surface Co. As a result, as shown in FIG. 11, a plane shape of the other end portion 20e is a concave shape. By forming the other end portion 20e in this way, a clear difference in the shape from the one end portion 20d can be realized. Therefore, for example, when the inserting direction of the electronic component 10 fit in the holding tool 20 is designated, the holding tool 20 is attached after the other end portion 20e having the different shape is adjusted to the golf club 200 as an indicator of the inserting direction. It is possible to prevent the electronic component 10 from being inserted in a wrong direction. Note that the prevention of wrong attachment of the electronic component 10 is not limited to forming the shape of the other end portion 20e different from the shape of the one end portion 20d and may be application of a mark such as a simple marking.

Note that the holding tool 20 may include slip prevention protrusions 20f and 20g for the electronic component 10. The slip prevention protrusions 20f and 20g engage with not-shown engaging sections of the electronic component 10 when the electronic component 10 is inserted and prevent the electronic component 10 from coming off the holding tool 20. When the holding tool 20 includes the slip prevention protrusions 20f and 20g, the holding tool 20 may include pressing protrusions 20h and 20j that disengage the slip prevention protrusions 20f and 20g from the engaging sections of the electronic component 10 when the electronic component 10 is detached from the holding tool 20. When the electronic component 10 is detached from the holding tool 20, the pressing protrusions 20h and 20j are pressed in an arrow direction by a finger 300 as shown in FIG. 13 to reduce the distance between the slip prevention protrusions 20f and 20g and disengage the slip prevention protrusions 20f and 20g from the engaging sections of the electronic component 10. Consequently, the electronic component 10 can be detached from the holding tool 20.

An inserting state of the electronic component 10 into the holding tool 20 is explained. FIG. 14 is a schematic sectional view of a state in which the holding tool 20 is attached to the golf club 200. As shown in FIG. 14, the holding tool 20 is attached to the grip section 200a of the golf club 200. In the grip section 200a, a grip rubber 200c for slip prevention is covered or wound on the shaft section 200b. The grip rubber 200c is formed of an elastic material such as rubber or urethane elastomer. A repulsive force caused by compression of the grip rubber 200c between the attachment surface 20a of the holding tool 20 (the inner surface of the holding tool 20) and the shaft section 200b increases a frictional force between the holding tool 20 and the grip rubber 200c. It is possible to prevent the holding tool 20 from causing positional deviation from the golf club 200.

A form is illustrated in which the motion detecting device 100 according to this embodiment is attached to the golf club 200. However, for example, when slip preventing means is not provided in the grip section 200a as in a baseball bat, an elastic member like the grip rubber 200c shown in FIG. 14 may be clamped between the baseball bat and the attachment surface 20a of the holding tool 20. A slip prevention member functioning as a so-called clamped member may be disposed. As a material of the clamped member, elastic resin such as rubber or urethane elastomer, soft metal, or the like is desirable.

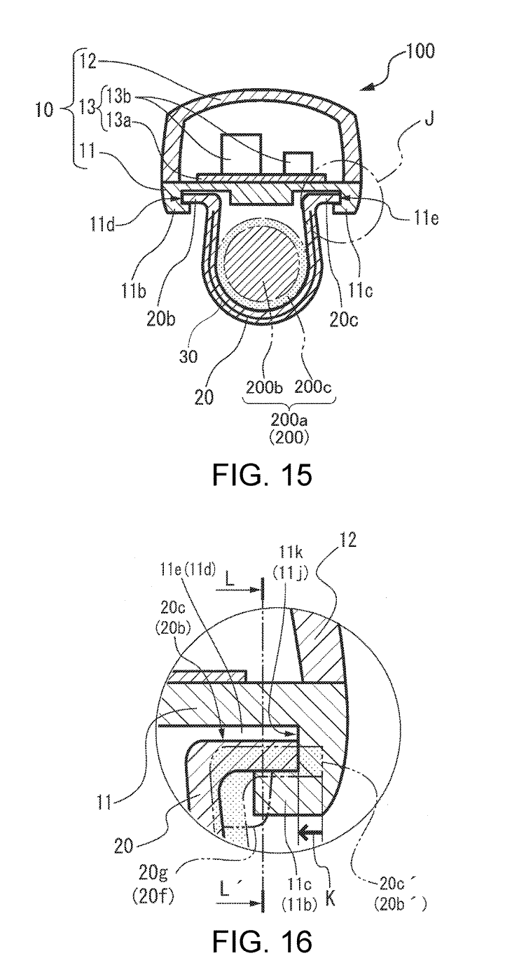

FIG. 15 is a schematic sectional view of a state in which the electronic component 10 is fit in the holding tool 20. Specifically, FIG. 15 is an assembled sectional view in a position equivalent to a B-B′ part shown in FIGS. 6 and 7 in a state in which the holding tool 20 and the electronic component 10 are assembled. FIG. 16 is an enlarged view of a range indicated by J in FIG. 15. For the assembling of the motion detecting device 100, the electronic component 10 is moved in the arrow direction to the holding tool 20 attached to the golf club 200 as shown in FIG. 2. The fitting section 20b and the fitting section 20c included in the holding tool 20 are inserted through, specifically, slid and inserted into the groove 11d and the groove 11e formed in the electronic component 10 as shown in FIG. 15. Consequently, the electronic component 10 is attached to the holding tool 20 attached to the golf club 200 and assembled into the motion detecting device 100.

As shown in FIG. 14, when the holding tool 20 is attached to the grip section 200a of the golf club 200, the grip rubber 200c of the grip section 200a is clamped between the attachment surface 20a of the holding tool 20 and the shaft section 200b. In this state, an attachment opening 20k opposed to the attachment surface 20a is displaced to be expanded by the elasticity of the grip rubber 200c. The fitting section 20b and the fitting section 20c change to a state of a fitting section 20b′ and a fitting section 20c′ moved to the outer side.

When the fitting section 20b and the fitting section 20c are inserted through the groove 11d and the groove 11e in the state of the fitting section 20b′ and the fitting section 20c′ as shown in FIG. 15, the fitting section 20b and the fitting section 20c are rectified in an arrow K direction shown in the figure by a groove wall surface 11j of the groove 11e and a groove wall surface 11k of the groove 11d as shown in FIG. 16. That is, in a state of the motion detecting device 100 shown in FIG. 15, the holding tool 20 is rectified to a direction for compressing the grip rubber 200c. It is possible to increase holding force of the holding tool 20 for holding the grip section 200a. Therefore, it is possible to surely position the motion detecting device 100 with respect to the golf club 200. The motion detecting device 100 is less easily positionally deviated by an inertial force or an impulsive force applied to the motion detecting device 100 by a swing of the golf club 200. It is possible to acquire appropriate swing data of the golf club 200.

As explained above, with the motion detecting device 100 according to the embodiment, it is possible to obtain effects explained below.

The motion detecting device 100 in the embodiment includes the electronic component (the sensor) 10 including the sensor section 13 including the terrestrial magnetism sensor that detects motion on the basis of a detection result of the detection element that detects magnetism and the holding tool 20 attached to the golf club (the moving body) 200 to fix the electronic component (the sensor) 10. The magnetic body 30 is provided in the holding tool 20.

With this configuration, when motion such as swing motion of the golf club 200 is detected, it is possible to reduce, with the magnetic body 30 provided in the holding tool 20, disturbance of terrestrial magnetism caused around the metal shaft section 200b of the golf club 200 and suppress a detection error of motion due to the disturbance of the terrestrial magnetism.

In the motion detecting device 100 in the embodiment, the magnetic body 30 is disposed to be symmetrical with respect to the imaginary center line P passing the golf club (the moving body) 200 along the direction in which the electronic component (the sensor) 10 and the holding tool 20 are arranged side by side.

Consequently, in a state in which the electronic component (the sensor) 10 is fixed to the holding tool 20 attached to the golf club 200, the magnetic body 30 is disposed in a well-balanced state with respect to the golf club 200 (the shaft section 200b). Therefore, when motion such as swing motion of the golf club 200 is detected, it is possible to more effectively suppress the influence of the disturbance of the terrestrial magnetism.

In the embodiment, the magnetic body 30 is disposed on the inside of the holding tool 20.

With this configuration, since the magnetic body 30 is not in contact with and is not exposed to the golf club 200 functioning as the moving body and an external environment, damage, soil, and the like due to friction and the like less easily occur. Therefore, it is possible to retain the suppression effect of the detection error of the motion detection by the magnetic body 30.

In the embodiment, the fitting sections 20b and 20c and the grooves 11d and 11e corresponding thereto are respective provided in the holding tool 20 and the electronic component (the sensor) 10. The electronic component (the sensor) 10 and the holding tool 20 are fixed by fitting the fitting sections and the grooves corresponding to each other.

Consequently, it is possible to obtain the motion detecting device 100 easily attached to the golf club 200 functioning as the moving body.

Note that the invention is not limited to the embodiment. Various changes, improvements, and the like can be added to the embodiment. Modifications are explained below.

### Modifications

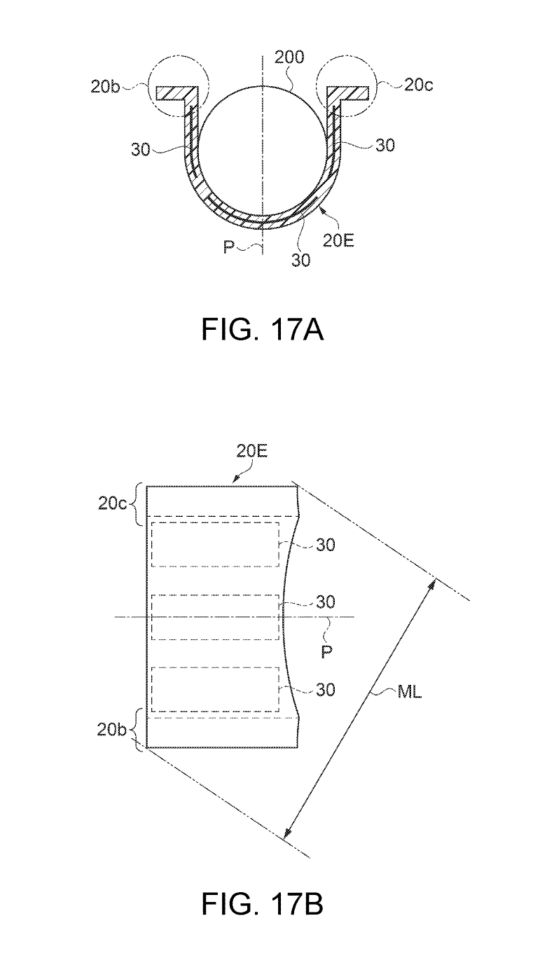

FIG. 17A is a sectional view schematically showing an example of the magnetic body 30 included in a holding tool 20E according to a modification 1. FIG. 17B is an explanatory diagram equivalent to a state in which the holding tool 20E according to the modification 1 is imaginarily developed on a plane.

In the embodiment, as shown in FIGS. 5A to 5C, the magnetic body 30 of one component is provided on the inside of the holding tool 20. However, the invention is not limited to this configuration.

The holding tool 20E according to the modification 1 is explained below. Note that components same as the components in the embodiment are denoted by the same reference numerals and signs and redundant explanation of the components is omitted.

In FIGS. 17A and 17B, a plurality of divided magnetic bodies 30 are provided to be embedded in the holding tool 20E according to the modification 1. In this modification, three divided magnetic bodies 30 having the same size are provided on the inside of the holding tool 20E. In a state in which the electronic component (the sensor) 10 is fixed to the holding tool 20E, the plurality of divided magnetic bodies 30 are desirably disposed to be symmetrical with respect to the imaginary center line P passing the golf club 200 along a direction in which the electronic component (the sensor) 10 and the holding tool 20E are arranged side by side. The disposition symmetrical with respect to the imaginary center line P is desirably applied when the plurality of divided magnetic bodies 30 have sizes different from one another.

As explained above, with the holding tool 20E according to the modification 1, like the effects in the embodiment, in the state in which the electronic component (the sensor) 10 is fixed, when motion of the golf club (the moving body) 200 is detected, it is possible to suppress disturbance of terrestrial magnetism around the shaft section 200b and reduce a detection error.

### Modification 2

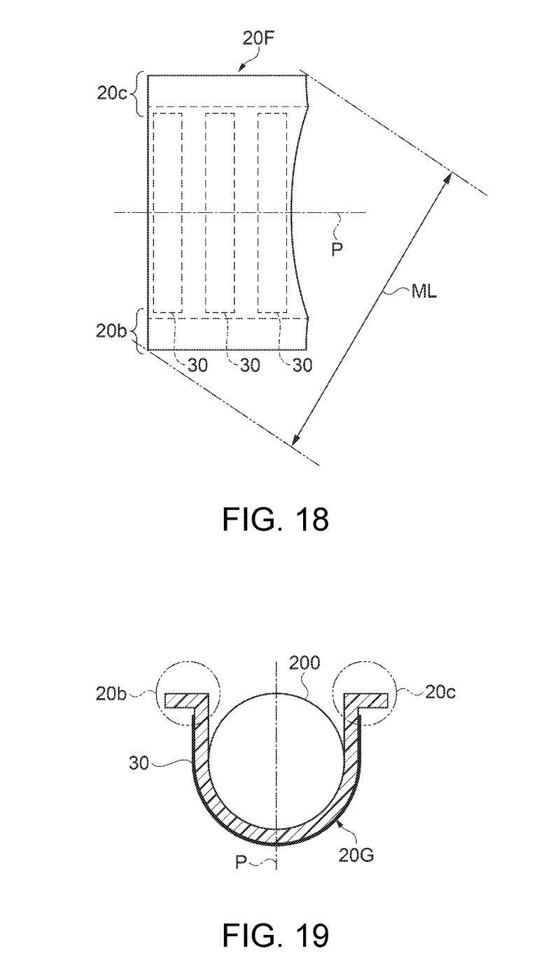

FIG. 18 is an explanatory diagram equivalent to a state in which a holding tool 20F according to a modification 2 is imaginarily developed on a plane. A form of the magnetic body 30 in the holding tool 20F according to the modification 2 is different from the dividing and disposing direction of the magnetic body 30 in the modification 1. In the holding tool 20E in the modification 1, the plurality of divided magnetic bodies 30 are disposed to be symmetrical with respect to the imaginary center axis P passing the golf club 200 along the direction in which the electronic component (the sensor) 10 and the holding tool 20E are arranged side by side and are disposed in parallel to one another. On the other hand, in the holding tool 20F in the modification 2, the plurality of (in this modification, three) divided magnetic bodies 30 are disposed to be symmetrical with respect to the imaginary center line P and disposed to cross one another (in this modification, to be orthogonal to one another).

With the holding tool 20F according to the modification 2 explained above, as in the embodiment and the modification 1, when motion of the golf club 200 (the moving body) is detected in the motion detecting device 100 to which the electronic component (the sensor) 10 is fixed, it is possible to suppress, with the magnetic bodies 30, disturbance of terrestrial magnetism caused around the golf club 200 (the shaft section 200b) and perform accurate detection of motion.

### Modification 3

FIG. 19 is a sectional view schematically showing an example of the magnetic body 30 included in a holding tool 20G according to a modification 3.

In the embodiment and the modification 1 and the modification 2, as shown in FIGS. 5A to 5C, 17A and 17B, and 18, the magnetic body 30 is provided on the insides of the holding tools 20, 20E, and 20F. However, the invention is not limited to this configuration.

The holding tool 20G according to the modification 3 is explained below. Note that components same as the components in the embodiment and the modification 1 and the modification 2 are denoted by the same reference numerals and signs and redundant explanation of the components is omitted.

In the holding tool 20G in the modification 3 shown in FIG. 19, the magnetic body 30 is disposed on a surface opposite to a contact surface with the golf club 200 functioning as the moving body.

With this configuration, the holding tool 20G provided with the magnetic body 30 can be formed by a simple method of sticking the magnetic body 30 to the holding tool 20G. The holding tool 20G is held on the golf club 200 in a state in which the magnetic body 30 is not in contact with the golf club (the moving body) 200. Therefore, it is possible to prevent occurrence of scratches and soil due to contact of the magnetic body 30 with the moving body.

### Modification 4

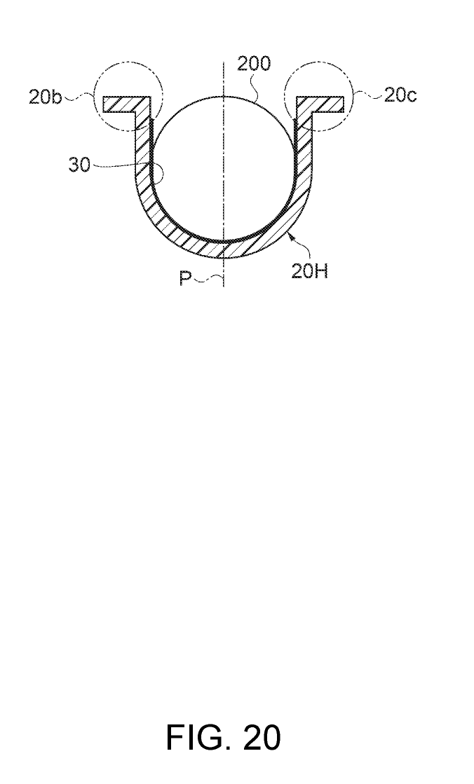

FIG. 20 is a sectional view schematically showing an example of the magnetic body 30 included in a holding tool 20H according to a modification 4. In the holding tool 20H in the modification 4, the magnetic body 30 is disposed on a surface opposite to the setting surface of the magnetic body 30 in the holding tool 20G in the modification 3. That is, in the holding tool 20H in the modification 4 shown in FIG. 20, the magnetic body 30 is disposed on a contact surface with the golf club (the moving body) 200.

With this configuration, the holding tool 20H provided with the magnetic body 30 can be formed by a simple method of sticking the magnetic body 30 to the holding tool 20H. The magnetic body 30 is disposed on the contact surface side of the golf club (the moving body) 200. Therefore, there is an effect that the magnetic body 30 is protected from friction and damage due to contact with the outside during use (during detection of motion).

Note that, in the configuration in which the magnetic body 30 is provided on the surface on the outer side of the holding tools 20G and 20H in the modification 3 and the modification 4, by forming a protection film formed of resin or the like on the surface of the magnetic body 30, it is possible to prevent damage such as scratches and soil of the magnetic body 30 due to contact with the moving body such as the golf club 200, an external environment, and an object.

2. Exercise Instrument Attached with a Sensor

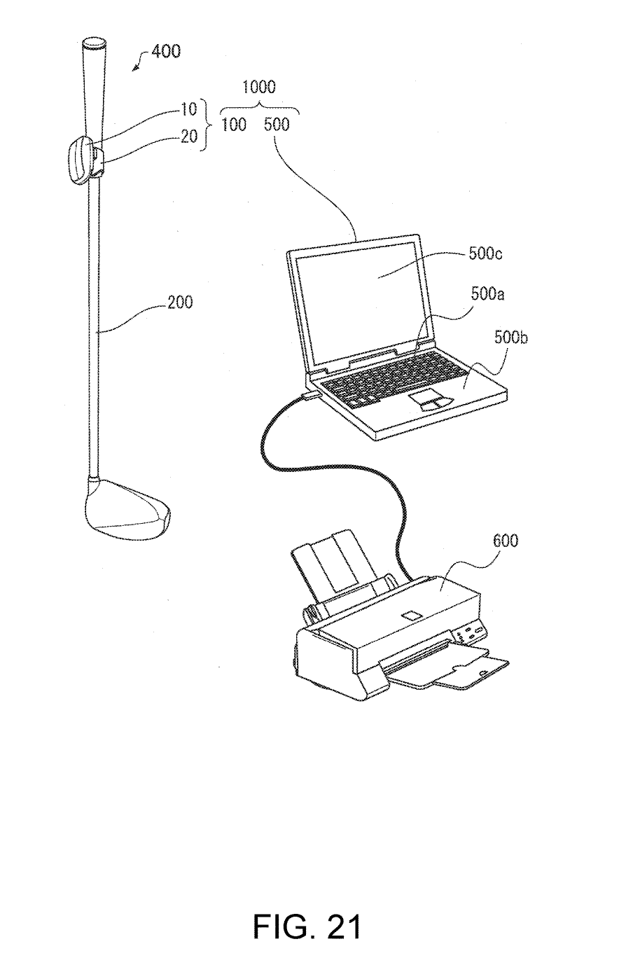

In FIGS. 3 and 21, the exercise instrument 400 attached with the sensor is an exercise instrument such as the golf club 200. The motion detecting device 100 is attached to the exercise instrument 400 attached with the sensor. In the exercise instrument 400 attached with the sensor, the magnetic body 30 is provided in the holding tool 20 as explained above. Therefore, it is possible to perform, with high sensitivity, information communication by a radio wave with an external communication apparatus (a portable information terminal such as a smartphone, a personal computer, and the like). It is possible to perform highly accurate motion analysis.

### 3. Motion Analyzing System

FIG. 21 is an exterior view of a motion analyzing system 1000 including the motion detecting device 100 in the embodiment. As shown in FIG. 21, the motion analyzing system 1000 according to this embodiment includes the motion detecting device 100 and a computer 500 that acquires motion data of the golf club 200 functioning as the moving body obtained by the motion detecting device 100 and analyzes the motion data. The computer 500 includes a processing section 500b including an input section 500a and a display section 500c that displays a processing result. In an example shown in the figure, the motion analyzing system 1000 includes a personal computer 500 (hereinafter referred to as PC 500). However, a portable terminal such as a tablet terminal or a smartphone may be connected to the motion detecting device 100 by radio. The motion analyzing system 1000 may include a printer 600 functioning as an external output in order to record an analysis result of the PC 500. Note that, in this embodiment, transmission and reception of data is performed by radio communication between the motion detecting device 100 and the PC 500.

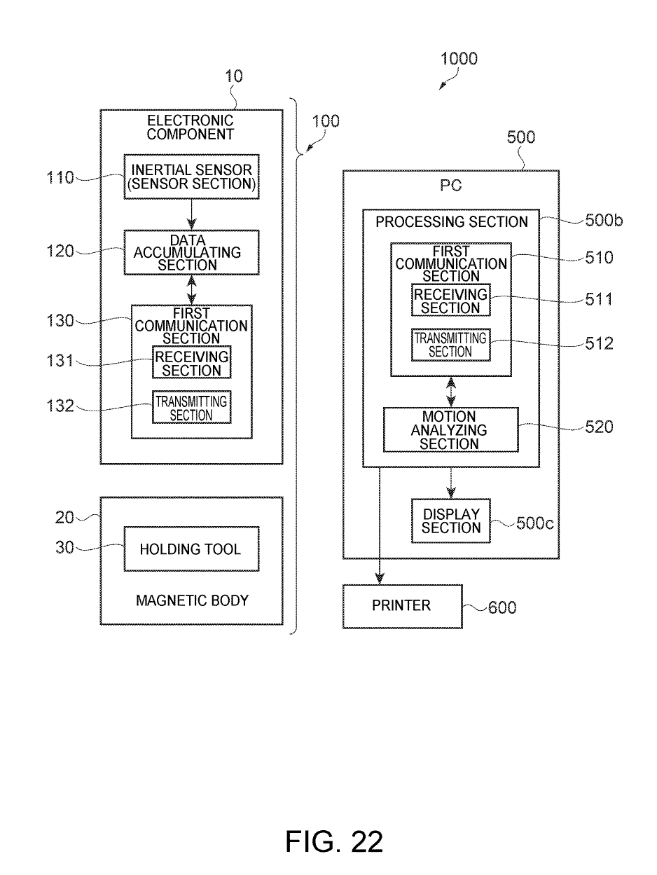

In FIG. 22, a block diagram of the motion analyzing system 1000 shown in FIG. 21 is shown. As shown in FIG. 22, the electronic component 10 included in the motion detecting device 100 includes at least a sensor section 110 including at least a terrestrial magnetism sensor, a data accumulating section 120 functioning as a data acquiring section that stores, while performing data processing, detection data detected by a sensor such as the terrestrial magnetism sensor of the sensor section 110, and a first communication section 130 including a transmitting section 132 that transmits data to the PC 500 and a receiving section 131 that receives transmission from the PC 500. The PC 500 functioning as an analyzing apparatus includes the processing section 500b, which includes a second communication section 510 including a receiving section 511 that receives data transmitted from the first communication section 130 of the electronic component 10 and a transmitting section 512 that transmits a radio wave to the first communication section 130 and a motion analyzing section 520 that performs data processing of acquired detection data and analyzes the detection data, and the display section 500c that displays an analysis result in the motion analyzing section 520. The PC 500 includes the printer 600 as an external output of an analysis result.

An example of the operation of the motion analyzing system 1000 is explained. When the golf club 200 attached with the motion detecting device 100 is swung, the sensor section 110 detects swing motion and sends detection data to the data accumulating section 120. In this embodiment, the terrestrial magnetism sensor at least included in the sensor section 110 detects the swing motion of the golf club 200 as a temporal terrestrial magnetism change and outputs detection data of the swing motion to the data accumulating section 120. The data accumulating section 120 processes the input detection data into a data format that can be transmitted to the PC 500 and then accumulates (stores) the detection data until a transmission instruction from the PC 500 is received. When a predetermined swing for motion analysis ends, work for the motion analysis is started. When the input section 500a (see FIG. 21) of the PC 500 gives a command for an analysis start to the processing section 500b, the transmitting section 512 of the second communication section 510 transmits an instruction for detection data transmission to the first communication section 130. The first communication section 130 receives the instruction for detection data transmission. The transmitting section 132 transmits, on the basis of the command transferred to the receiving section 131 of the first communication section 130, the detection data stored in the data accumulating section 120 to the processing section 500b by, for example, a radio wave.

The detection data received by the receiving section 511 of the second communication section 510 is sent to the motion analyzing section 520. Motion analysis of the golf club 200 is executed on the basis of a predetermined analysis program. An analysis result is displayed on the display section 500c included in the PC 500 as an image or recorded in a recording medium and output by the printer 600 functioning as the external output.

With the motion analyzing system 1000 explained above, since the motion analyzing system 1000 includes the motion detecting device 100, by attaching the motion detecting device 100 to the moving body (e.g., the golf club 200), it is possible to reduce disturbance of terrestrial magnetism caused around the moving body, acquire motion data with a suppressed detection error of motion due to the disturbance of the terrestrial magnetism, and perform motion analysis on the basis of the motion data. Therefore, it is possible to provide the motion analyzing system 1000 capable of performing more highly accurate motion analysis.

In the motion analyzing system 1000, the motion detecting device 100 can be easily attached to and detached from the illustrated moving body (the golf club 200). Therefore, for example, even when characteristics of a plurality of moving bodies are analyzed, at least one set of the motion detecting device 100 only has to be prepared. Therefore, it is possible to reduce expenses for the analysis. Since the sensor is not attached to the moving body by bonding means, time for the analysis preparation is reduced, the sensor is easily detached from the moving body after the analysis, and analysis time is reduced, and adhesion of soil of an adhesive or the like to the moving body is prevented. It is possible to perform analysis of a motion characteristic of the moving body without reducing a commercial value of the moving body.

The invention is not limited to the embodiment and various modifications of the embodiment are possible. For example, the invention includes components substantially the same as the components explained in the embodiment (e.g., components having the same functions, methods, and results or components having the same objects and effects). The invention includes components obtained by replacing unessential portions of the components explained in the embodiment. The invention includes components that show action and effects same as the action and effects of the components explained in the embodiment or components that can achieve objects same as the objects of the components explained in the embodiment. The invention includes components obtained by adding publicly-known techniques to the components explained in the embodiment.

The entire disclosure of Japanese Patent Application No. 2015-215501 filed Nov. 2, 2015 is expressly incorporated by reference herein.

What is claimed is:

1. A motion detecting device comprising:
a sensor including a detection element configured to detect magnetism; and
a holding tool attached to a moving body and including a fixing section configured to fix the sensor, wherein
a magnetic body is provided in the holding tool.

2. The motion detecting device according to claim 1, wherein the magnetic body is a ferromagnetic body.

3. The motion detecting device according to claim 1, wherein the magnetic body is disposed to be symmetrical with respect to an imaginary center line extending along a direction in which the sensor and the holding tool are arranged side by side and passing the moving body.

4. The motion detecting device according to claim 1, wherein the magnetic body is disposed on an inside of the holding tool.

5. The motion detecting device according to claim 1, wherein the magnetic body is disposed on a surface of the holding tool on the moving body side.

6. The motion detecting device according to claim 1, wherein the magnetic body is disposed on a surface on an opposite side of a surface of the holding tool on the moving body side.

7. The motion detecting device according to claim 1, wherein
fitting sections are respectively provided in the holding tool and the sensor, and
the sensor and the holding tool are fixed by fitting the fitting sections with each other.

8. A motion analyzing system comprising:
the motion detecting device according to claim 1;
a data acquiring section configured to acquire motion data of the moving body obtained by the motion detecting device; and
a computer configured to analyze the motion data acquired by the data acquiring section.

9. A motion analyzing system comprising:
the motion detecting device according to claim 2;
a data acquiring section configured to acquire motion data of the moving body obtained by the motion detecting device; and
a computer configured to analyze the motion data acquired by the data acquiring section.

10. A motion analyzing system comprising:
the motion detecting device according to claim 3;
a data acquiring section configured to acquire motion data of the moving body obtained by the motion detecting device; and
a computer configured to analyze the motion data acquired by the data acquiring section.

11. A motion analyzing system comprising:
the motion detecting device according to claim 4;
a data acquiring section configured to acquire motion data of the moving body obtained by the motion detecting device; and
a computer configured to analyze the motion data acquired by the data acquiring section.

12. A motion analyzing system comprising:
the motion detecting device according to claim 5;
a data acquiring section configured to acquire motion data of the moving body obtained by the motion detecting device; and
a computer configured to analyze the motion data acquired by the data acquiring section.

13. A motion analyzing system comprising:
the motion detecting device according to claim 6;
a data acquiring section configured to acquire motion data of the moving body obtained by the motion detecting device; and
a computer configured to analyze the motion data acquired by the data acquiring section.
